(19) United States
(12) Patent Application Publication
(10) Pub. No.: US 2026/0161175 A1
(43) Pub. Date: Jun. 11, 2026

(54) AUTOMATIC TRANSPORT SYSTEM AND METHOD FOR AUTOMATIC TRANSPORT USING THE SAME

(71) Applicant: Samsung Display Co., LTD., Yongin-si (KR)

(72) Inventors: Sung Hwi KIM, Yongin-si (KR); Chae Ho KIM, Yongin-si (KR); Jung Il KIM, Yongin-si (KR); Ji Min HAN, Yongin-si (KR)

(21) Appl. No.: 19/181,790

(22) Filed: Apr. 17, 2025

(30) Foreign Application Priority Data
Aug. 13, 2024 (KR) 10-2024-0108266

(51) Int. Cl. G05D 1/644; G05D 1/249; G05D 101/00; G05D 107/70

(52) U.S. Cl. CPC G05D 1/644; G05D 1/249; G05D 2101/22; G05D 2107/70

(57) ABSTRACT

An automatic transport system includes first transport equipment transporting a cargo along a first path, second transport equipment transporting the cargo along a second path, the second transport equipment being of a different type from the first transport equipment, one or more cameras disposed on the first path and the second path to capture images of the first path and the second path, a host controller configured to issue a command to transport the cargo, and an integrated controller configured to control the first transport equipment and the second transport equipment pursuant to the command to transport from the host controller.

This application claims priority to Korean Patent Application No. 10-2024-0108266, filed on Aug. 13, 2024, and all the benefits accruing therefrom under 35 U.S.C. § 119, the content of which in its entirety is herein incorporated by reference.

### BACKGROUND

### 1. Field of the Disclosure

The invention relates generally to an automatic transport system, and more particularly to an automatic transport system and a method for automatic transport using the same.

### 2. Description of the Related Art

Logistics includes physical distribution processes that include the process of transporting, unloading, storing, and packaging cargo. In order to prevent cargo from being contaminated or damaged during the transportation or to prevent transport accidents, an automatic transport system is utilized in fabrication lines.

Cargo is transported by various transport equipment such as automated guided vehicles (AGV) and overhead shuttles (OHS). Such various transport equipment is controlled individually by a separate transport system that controls the respective transport equipment.

### SUMMARY

Aspects of the invention provide an automatic transport system that can control different types of transport equipment for transporting cargo with a single integrated controller, and a method for automatic transport using the same.

Aspects of the invention are not restricted to those set forth herein. The above and other aspects of the invention will become more apparent to one of ordinary skill in the art to which the invention pertains by referencing the detailed description of the invention given below.

According to an aspect, an automatic transport system includes first transport equipment transporting a cargo along a first path, second transport equipment transporting the cargo along a second path, the second transport equipment being of a different type from the first transport equipment, one or more cameras disposed on the first path and the second path to capture images of the first path and the second path, a host controller configured to issue a command to transport the cargo, and an integrated controller configured to control the first transport equipment and the second transport equipment pursuant to the command to transport from the host controller.

In an embodiment, the integrated controller includes a transport path generator that generates an optimal transport path of the cargo based on the command to transport, a transport equipment selector that selects one or more of the first transport equipment and the second transport equipment based on the optimal transport path, a transport instructor that instructs the transport equipment selected by the transport equipment selector to transport the cargo, and a transport status checker that checks a status of the selected transport equipment transporting the cargo pursuant to the instruction of the transport instructor.

In an embodiment, the host controller issues the command to transport the cargo from an initial location to a destination location, wherein the transport path generator analyzes the images captured by the camera to generate an optimal transport path for transporting the cargo from the initial location to the destination location.

In an embodiment, the transport equipment selector selects the first transport equipment if the optimal transport path generated by the transport path generator includes the first path, selects the second transport equipment if the optimal transport path generated by the transport path generator includes the second path, and selects the first transport equipment and the second transport equipment if the optimal transport path generated by the transport path generator includes the first path as well as the second path.

In an embodiment, if both the first transport equipment and the second transport equipment are selected by the transport equipment selector, the cargo is moved from the first transport equipment to the second transport equipment, or from the second transport equipment to the first transport equipment.

In an embodiment, the integrated controller further includes a transport priority sorter that sorts transport priorities of commands to transport, and wherein the transport priority sorter sorts multiple commands in issued order if the multiple commands are issued from the host controller, and the transport path generator generates optimal transport paths for the commands in the issued order.

In an embodiment, the transfer priority sorter sorts an urgent command as a highest priority if the urgent command is issued from the host controller.

In an embodiment, he transport status checker includes a transport path checking unit that checks whether the transport equipment deviates from the optimal transport path, a transport equipment status checking unit that checks whether there is an abnormality in the transport equipment, and a transport equipment restart determining unit that determines whether to restart the transport equipment if it is determined by the transport equipment status checking unit that there is the abnormality in the transport equipment.

In an embodiment, the transport status checker further includes a cargo status checking unit that checks whether the cargo has deviated from the transport equipment if it is determined by the transport equipment restart determining unit that the transport equipment is able to be restarted.

In an embodiment, the transport status checker further includes a transport equipment restart executing unit that restarts the transport equipment if it is determined by the transport equipment restart determining unit that the transport equipment is able to be restarted and it is determined by the cargo status checking unit that the cargo has not deviated from the transport equipment.

In an embodiment, the first transport equipment includes a first status check sensor that checks a current status of the first transport equipment, and the second transport equipment includes a second status check sensor that checks a current status of the second transport equipment.

In an embodiment, the first transport equipment is one selected from among an over head shuttle (OHS), a tray over head shuttle (TOHS), an automatic guided vehicle (AGV), a laser guided vehicle (LGV), a rail guided vehicle (RGV), and an autonomous mobile robot (AMR), and wherein the second transport equipment is one selected from among an over head shuttle (OHS), a tray over head shuttle (TOHS), an automatic guided vehicle (AGV), a laser guided vehicle (LGV), a rail guided vehicle (RGV), and an autonomous mobile robot (AMR).

According to an aspect, a method for automatic transport includes issuing, by a host controller, a command to transport cargo, capturing, by a camera, images of a first path and a second path, generating, by a transport path generator, an optimal transport path for the cargo based on the command to transport, selecting, by a transport equipment selector, at least one of the first transport equipment and the second transport equipment based on the optimal transport path, instructing, by a transport instructor, the selected transport equipment to transport the cargo, and checking, by a transport status checker, a status of the selected transport equipment transporting the cargo.

In an embodiment, the command to transport is a command to transport the cargo from an initial location to a destination location, wherein the generating the optimal transport path for the cargo includes analyzing, by the transport path generator, the images captured by the camera to generate the optimal transport path for transporting the cargo from the initial location to the destination location.

In an embodiment, the selecting the transport equipment includes selecting, by the transport equipment selector, the first transport equipment if the optimal transport path includes the first path, selecting, by the transport equipment selector, the second transport equipment if the optimal transport path includes the second path, and selecting, by the transport equipment selector, the first transport equipment and the second transport equipment if the optimal transport path includes the first path as well as the second path.

In an embodiment, the method for automatic transport further includes sorting, by the transfer priority sorter, transport priorities of multiple commands if the host controller issues the multiple commands.

In an embodiment, the sorting the transport priorities of the multiple commands includes sorting, by the transport priority sorter, the multiple commands in the issued order, and sorting an urgent command as a highest priority if there is the urgent command among the multiple commands.

In an embodiment, the transport status checker includes a transport path checking unit, a transport equipment status checking unit, and a transport equipment restart determining unit, wherein the checking the status of the selected transport equipment transporting the cargo includes checking, by transport path checking unit, whether the transport equipment deviates from the optimal transport path, checking, by the transport equipment status checking unit, whether there is an abnormality in the transport equipment, and determining, by the transport equipment restart determining unit, whether to restart the transport equipment if it is determined by the transport equipment status checking unit that there is an abnormality in the transport equipment.

In an embodiment, the transport status checker further includes a cargo status checking unit, wherein the checking the status of the selected transport equipment transporting the cargo further includes checking, by the cargo status checking unit, whether the cargo has deviated from the transport equipment if it is determined by the transport equipment restart determining unit that the transport equipment is able to be restarted.

In an embodiment, the transport status checker further includes a transport equipment restart executing unit, wherein the checking the status of the selected transport equipment transporting the cargo further includes restarting, by the transport equipment restart executing unit, the transport equipment if it is determined by the transport equipment restart determining unit that the transport equipment is able to be restarted and is determined by the cargo status checking unit that the cargo has not deviated from the transport equipment.

According to an embodiment, by controlling different types of transport equipment for transporting cargo with a single integrated controller in an automatic transport system, it is possible to efficiently operate the transport equipment, and quickly deal with problems that may occur in the transport system.

The effects, according to the embodiments, are not limited to those mentioned above and more various effects are included in the following description of the present disclosure.

### BRIEF DESCRIPTION OF THE DRAWINGS

The above and other aspects and features of the invention will become more apparent by describing in detail example embodiments thereof with reference to the attached drawings, in which:

FIG. 1 is a block diagram showing an automatic transport system, according to an embodiment.

FIG. 2 is a schematic diagram showing a first path and a second path along which first transport equipment and second transport equipment of FIG. 1 move, according to an embodiment.

FIG. 3 is a block diagram of an integrated controller of FIG. 1, according to an embodiment.

FIG. 4 is a block diagram of a transport status checker of FIG. 3, according to an embodiment.

FIG. 5 is a block diagram of an automatic transport system, according to an embodiment.

FIG. 6 is a flowchart for illustrating a method for automatic transfer, according to an embodiment.

FIG. 7 is a flowchart for illustrating a method for checking the status of the transport equipment transporting cargo in FIG. 6, according to an embodiment.

FIG. 8 is a flowchart of FIG. 6, according to an embodiment.

FIG. 9 is a flowchart for illustrating the checking the transport status in FIG. 8, according to an embodiment.

FIG. 10 is a flowchart for illustrating the restarting in FIG. 8, according to an embodiment.

### DETAILED DESCRIPTION

Advantages and features of the invention and methods to achieve them will become apparent from the descriptions of example embodiments hereinbelow with reference to the accompanying drawings. However, the invention is not limited to example embodiments disclosed herein but may be implemented in various different ways. The example embodiments are provided for making the disclosure of the invention thorough and for fully conveying the scope of the invention to those skilled in the art.

As used herein, a phrase “an element A on an element B” refers to that the element A may be disposed directly on the element B and/or the element A may be disposed indirectly on the element B via another element C. Like reference numerals denote like elements throughout the descriptions. The figures, dimensions, ratios, angles, numbers of elements given in the drawings are merely illustrative and are not limiting.

Although terms such as first, second, etc. are used to distinguish arbitrarily between the elements such terms describe, and thus these terms are not necessarily intended to indicate temporal or other prioritization of such elements. These terms are used to merely distinguish one element from another. Accordingly, as used herein, a first element may be a second element within the technical scope of the present disclosure.

Features of various example embodiments of the invention may be combined partially or totally. As will be clearly appreciated by those skilled in the art, technically various interactions and operations are possible. Various example embodiments can be practiced individually or in combination.

Hereinafter, example embodiments of the invention will be described in detail with reference to the accompanying drawings.

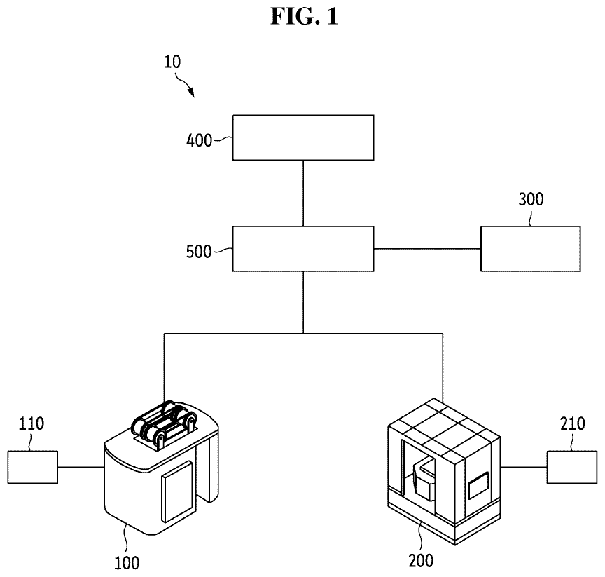

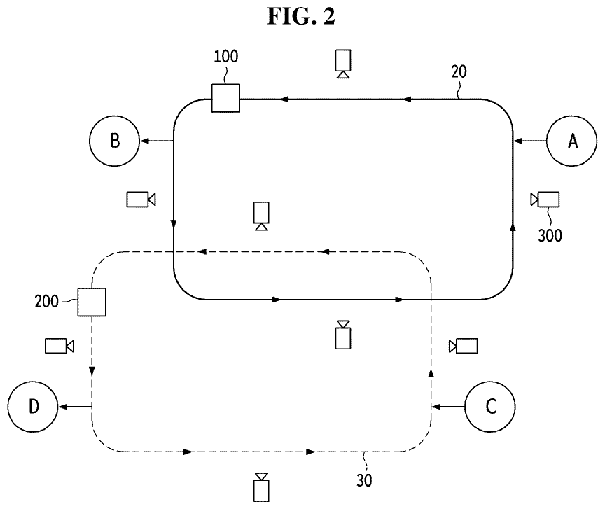

FIG. 1 is a block diagram showing an automatic transport system, according to an embodiment. FIG. 2 is a view schematically showing a first path and a second path along which first transport equipment and second transport equipment of FIG. 1 move, according to an embodiment.

In an embodiment and referring to FIGS. 1 and 2, an automatic transport system 10 may include first transport equipment 100, second transport equipment 200, a camera 300, a host controller 400, and an integrated controller 500. Although the automatic transport system 10 includes two different types of transport equipment, the invention is not limited thereto. For example, the automatic transport system 10 may include two or more different types of transport equipment.

In an embodiment, the first transport equipment 100 may transport a cargo along the first path 20, where the first transport equipment 100 may be one of an over head shuttle (OHS), a tray over head shuttle (TOHS), an automatic guided vehicle (AGV), a laser guided vehicle (LGV), a rail guided vehicle (RGV), and an autonomous mobile robot (AMR). For example, the first transport equipment 100 may be an over head shuttle (OHS). The over head shuttle (OHS) is transport equipment that transports cargo along a rail installed on the ceiling. Therefore, when the first transport equipment 100 is provided as an over head shuttle (OHS), the first path 20 may be a rail installed on the ceiling of the work site. The over head shuttle (OHS) can ensure an efficient space for transporting cargo in an area with a long transport distance and a large transport volume.

In an embodiment, the first transport equipment 100 may include a first status check sensor 110 which may be installed in the first transport equipment 100 and which may check the current status of the first transport equipment 100. For example, the first status check sensor 110 may check whether the first transport equipment 100 has been crashed or damaged. The first status check sensor 110 may check the current status of the first transport equipment 100 and may transmit the current status of the first transport equipment 100 to the integrated controller 500.

In an embodiment, the second transport equipment 200 may transport a cargo along the second path 30 and may be a different type of transport equipment than the first transport equipment 100. The second transport equipment 200 may be one of an over head shuttle (OHS), a tray over head shuttle (TOHS), an automatic guided vehicle (AGV), a laser guided vehicle (LGV), a rail guided vehicle (RGV), and an autonomous mobile robot (AMR). For example, the second transport equipment 200 may be an automatic guided vehicle (AGV). The automatic guided vehicle (AGV) is a transport device that transports cargo in a work site without a separate rail. If the second transport equipment 200 is provided as an automatic guided vehicle (AGV), the second path 30 may be the floor space of the work site. The second path 30 may at least partially overlap with the first path 20.

In an embodiment, the second transport equipment 200 may include a second status check sensor 210, where the second status check sensor 210 may be installed in the second transport equipment 200 and may check the current status of the second transport equipment 200. For example, the second status check sensor 210 may check whether the second transport equipment 200 has been crashed or damaged. The second status check sensor 210 may check the current status of the second transport device 200 and may transmit the current status of the second transport device 200 to the integrated controller 500.

In an embodiment, the camera 300 may be disposed on the first path 20 and the second path 30 to capture images of the first path 20 and the second path 30. For example, there may be a plurality of cameras 300, and the first path 20 and the second path 30 may be divided into multiple areas, so that the cameras 300 may be disposed at each of the divided areas of the first path 20 and the second path 30. In this manner, the cameras 300 disposed in the divided areas of the first path 20 and the second path 30 may capture the images of the areas and transmit the captured images to the integrated controller 500 in real time.

In an embodiment, the host controller 400 may issue a command to transport a cargo. In some embodiments, the host controller 400 may issue a command to transport a cargo from the initial location to the destination location. For example, the host controller 400 may issue a command to transport a cargo at location A of FIG. 2 to location B or location D. The command to transport a cargo issued from the host controller 400 may be set by an operator.

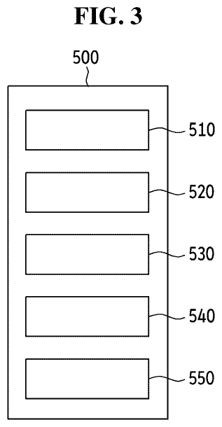

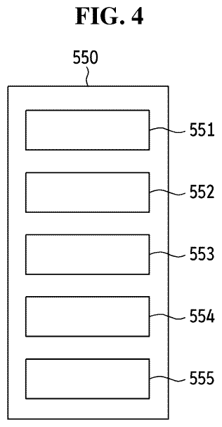

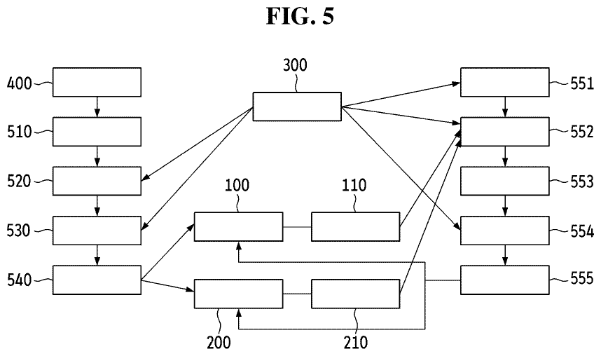

FIG. 3 is a block diagram of an integrated controller of FIG. 1, according to an embodiment. FIG. 4 is a block diagram of a transport status checker of FIG. 3, according to an embodiment. FIG. 5 is a block diagram of an automatic transport system, according to an embodiment.

In an embodiment and referring further to FIGS. 3 to 5, the integrated controller 500 may control the first transport equipment 100 and the second transport equipment 200 pursuant to the command to transport from the host controller 400. The integrated controller 500 may include a transport priority sorter 510, a transport path generator 520, a transport equipment selector 530, a transport instructor 540, and a transport status checker 550.

In an embodiment, the transport priority sorter 510 may sort the transport priorities of the commands issued from the host controller 400. For example, when multiple commands are issued from the host controller, the transport priority sorter 510 may sort the multiple commands in the issued order. If there is an urgent command to transport among the multiple commands, the transport priority sorter 510 may sort the urgent command as the highest priority. The transport priority sorter 510 may sort the multiple commands and transmit them to the transport path generator 520.

In an embodiment, the transport path generator 520 may generate the optimal transport path for the cargo based on the command. The transport path generator 520 may generate the optimal transport path for each of the sorted multiple commands. If the command is to transport a cargo from the initial location to the destination location, the transport path generator 520 may analyze the captured images of the camera 300 to generate the optimal transport path for transporting the cargo from the initial location to the destination location. For example, if the command is to transport a cargo from location A to location B in FIG. 2, the transport path generator 520 may generate the first path 20 as the optimal transport path. In addition, if the command is to transport a cargo from location A to location D in FIG. 2, the transport path generator 520 may generate the optimal transport path including the first path 20 and the second path 30. In addition, if the command is to transport a cargo from location C to location D in FIG. 2, the transport path generator 520 may generate the second path 30 as the optimal transport path. In addition, if the command is to transport a cargo from location C to location B in FIG. 2, the transport path generator 520 may generate the optimal transport path including the first path 20 and the second path 30. The optimal transport path generated by the transport path generator 520 may be transmitted to the transport equipment selector 530.

In an embodiment, the transport equipment selector 530 may select one or more of the first transport equipment 100 and the second transport equipment 200 based on the optimal transport path and the captured images of the camera 300. If the optimal transport path includes only the first path 20, the transport equipment selector 530 may select the first transport equipment 100 as the transport equipment to transport the cargo. For example, if the command is to transport a cargo from location A to location B in FIG. 2, since the optimal transport path includes only the first path 20, the transport equipment selector 530 may select the first transport equipment 100 as the transport equipment to transport the cargo.

In an embodiment, if the optimal transport path includes only the second path 30, the transport equipment selector 530 may select the second transport equipment 200 as the transport equipment to transport the cargo. For example, if the command is to transport a cargo from location C to location D in FIG. 2, since the optimal transport path includes only the second path 30, the transport equipment selector 530 may select the second transport equipment 200 as the transport equipment to transport the cargo.

In addition, in an embodiment, if the optimal transport path includes both the first path 20 and the second path 30, the transport equipment selector 530 may select both the first transport equipment 100 and the second transport equipment 200 as transport equipment to transport the cargo.

In an embodiment, if the optimal transport path includes both the first path 20 and the second path 30, at the intersection where the first path 20 and the second path 30 overlap each other, the cargo may be moved from the first transport equipment 100 to the second transport equipment 200, or from the second transport equipment 200 to the first transport equipment 100.

In an embodiment, once the transport equipment to transport the cargo is selected by the transport equipment selector 530, the transport instructor 540 may instruct the selected transport equipment to transport the cargo. The transport instructor 540 may instruct the selected transport equipment to transport the cargo along the optimal transport path.

In an embodiment, the transport status checker 550 may check the status of the transport equipment transporting the cargo, which was selected by the transport instructor 540. The transport status checker 550 may include a transport path checking unit 551, a transport equipment status checking unit 552, a transport equipment restart determining unit 553, a cargo status checking unit 554, and a transport equipment restart executing unit 555.

In an embodiment, the transport path checking unit 551 may check whether the transport equipment transporting the cargo deviates from the optimal transport path. For example, the transport path checking unit 551 may receive the image of the transport equipment transporting the cargo captured in real time from the camera 300 and analyze the received captured image to check whether the transport equipment transporting the cargo deviates from the optimal transport path or not.

In an embodiment, the transport equipment status checking unit 552 may check whether there is an abnormality in the transport equipment transporting the cargo. For example, the transport equipment status checking unit 552 may receive the image of the transport equipment transporting the cargo captured in real time from the camera 300, may receive the current status of the transport equipment from the status check sensor of the transport equipment, and may analyze the transmitted captured image and the current status of the transport equipment. The transport equipment status checking unit 552 may analyze the transmitted captured image and the current status of the transport equipment to determine whether the transport equipment is normal or whether there is an abnormality, such as the transport equipment being damaged or colliding with other transport equipment.

In an embodiment, the transport equipment restart determining unit 553 may determine whether to restart the transport equipment if the transport equipment status checking unit 552 determines that there is an abnormality in the transport equipment transporting the cargo. The transport equipment restart determining unit 553 may determine whether to restart the transport equipment by comprehensively considering the degree of damage to the transport equipment, whether there is space to avoid other transport equipment that the transport equipment may collide with, etc.

In an embodiment, if it is determined by the transport equipment restart determining unit 553 that the transport equipment is able to be restarted, the cargo status checking unit 554 may check whether a cargo is deviated from the transport equipment. For example, the cargo status checking unit 554 may receive the image of the transport equipment captured in real time from the camera 300 and analyze the received captured image to check whether the cargo has deviated from the transport equipment or not.

In an embodiment, if it is determined by the transport equipment restart determining unit 553 that the transport equipment is able to be restarted and it is determined by the cargo status checking unit 554 that the cargo has not deviated from the transport equipment, the transport equipment restart executing unit 555 may restart the transport equipment.

Hereinafter, a method for automatic transport, according to an embodiment, will be described with reference to the accompanying drawings.

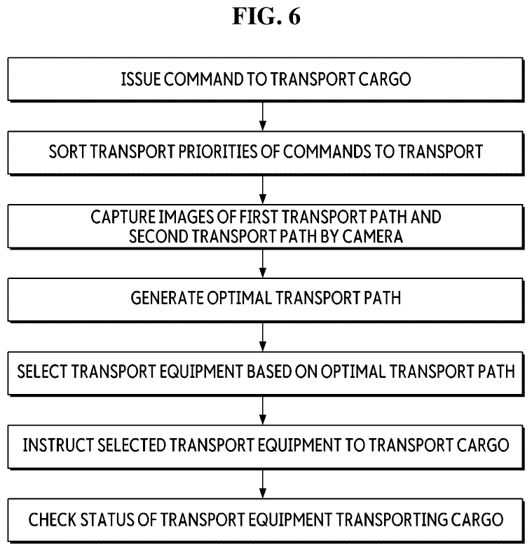

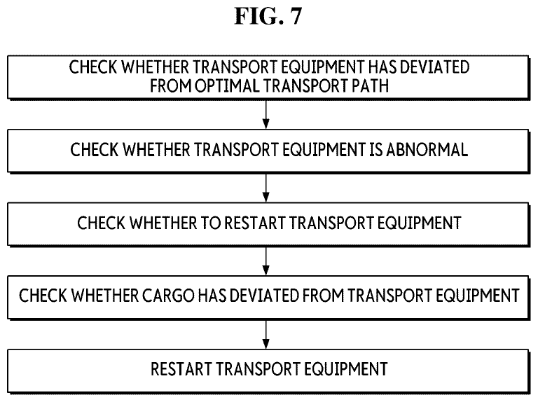

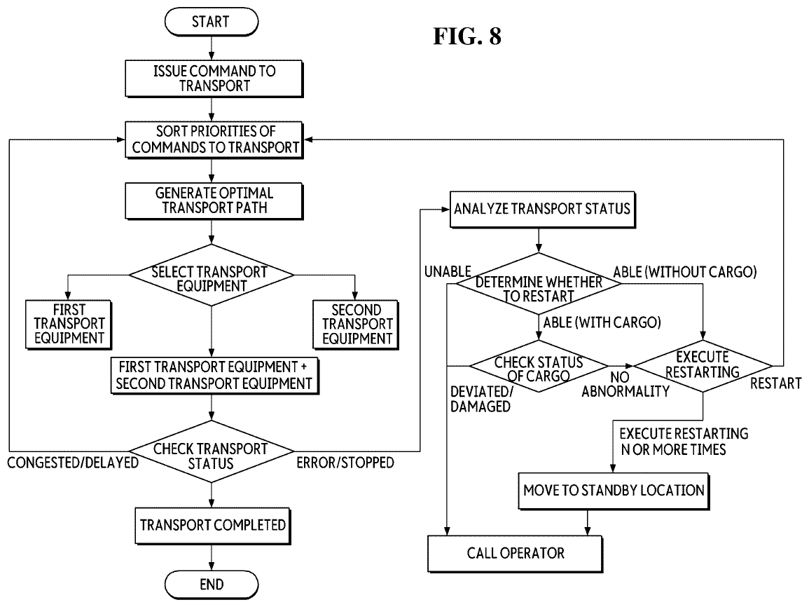

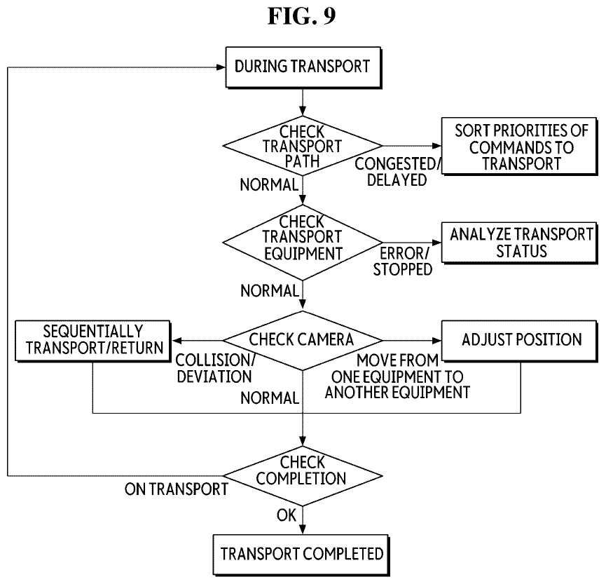

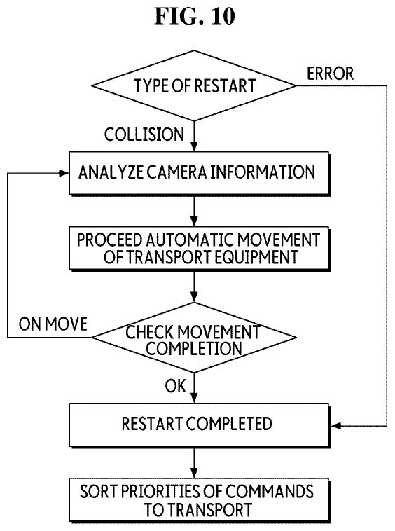

FIG. 6 is a flowchart for illustrating a method for automatic transport, according to an embodiment. FIG. 7 is a flowchart for illustrating a method for checking the status of the transport equipment transporting cargo in FIG. 6, according to an embodiment. FIG. 8 is a flowchart of FIG. 6, according to an embodiment. FIG. 9 is a flowchart for illustrating the checking the transport status in FIG. 8, according to an embodiment. FIG. 10 is a flowchart for illustrating the restarting in FIG. 8, according to an embodiment.

In an embodiment and referring to FIGS. 6 to 10, a method for automatic transport may include issuing, by a host controller 400, a command to transport a cargo, capturing, by a camera 300, images of a first path 20 and a second path 30, sorting, by a transport priority sorter 510, transport priorities of commands to transport, generating, by a transport path generator 520, an optimal transport path for the cargo based on the command to transport, selecting, by a transport equipment selector 530, at least one of first transport equipment 100 and second transport equipment 200 based on the optimal transport path, instructing, by a transport instructor 540, the selected transport equipment to transport the cargo and checking, by a transport status checker 550, a status of the selected transport equipment transporting the cargo.

In an embodiment, the issuing the command to transport the cargo may include transmitting, by the host controller 400, the command to transport the cargo to the transport priority sorter 510 when an operator inputs the command to transport the cargo to the host controller 400. The command may be a command to transport the cargo from the initial location to the destination location. For example, the host controller 400 may issue a command to transport a cargo at location A of FIG. 2 to location B or location D.

In an embodiment, the capturing, by the camera 300, the images of the first path 20 and the second path 30 may include capturing, by a plurality of cameras 300 disposed on the first path 20 and the second path 30, images of all of the first path 20 and the second path 30, where the capturing, by the camera 300, the images of the first path 20 and the second path 30 may be carried out continuously while the method for automatic transport is performed.

In an embodiment, the sorting, by the transport priority sorter 510, the transport priorities of the commands may include sorting the transport priorities of multiple commands when the host controller 400 issues multiple commands. The transport priority sorter 510 may sort the multiple commands in the issued order. If there is an urgent command to transport among the multiple commands, the transport priority sorter 510 may sort the urgent command as the highest priority. The transport priority sorter 510 may sort the multiple commands and transmit them to the transport path generator 520.

In an embodiment, the generating, by the transport path generator 520, the optimal transport path for a cargo based on the command may include generating the optimal transport path for each of the multiple commands sorted by the transport priority sorter 510.

In an embodiment, if the command is to transport a cargo from the initial location to the destination location, the transport path generator 520 may analyze the captured images of the camera 300 to generate the optimal transport path for transporting the cargo from the initial location to the destination location. For example, if the command is to transport a cargo from location A to location B in FIG. 2, the transport path generator 520 may generate the first path 20 as the optimal transport path. In addition, if the transfer command is to transfer a cargo from location A to location D in FIG. 2, the transfer path generator 520 may generate the optimal transfer path including the first path 20 and the second path 30. In addition, if the transfer command is to transfer a cargo from location C to location D in FIG. 2, the transfer path generator 520 may generate the second path 30 as the optimal transfer path. In addition, if the command is to transport a cargo from location C to location B in FIG. 2, the transport path generator 520 may generate the optimal transport path including the first path 20 and the second path 30. The optimal transport path generated by the transport path generator 520 may be transmitted to the transport equipment selector 530.

In an embodiment, the selecting one or more transport equipment among the first transport equipment 100 and the second transport equipment 200 based on the optimal transport path may include selecting, by the transport equipment selector 530, one or more transport equipment to transport the cargo based on the optimal transport path generated by the transport path generator 520 and the images captured by the camera 300.

In an embodiment, if the optimal transport path includes only the first path 20, the transport equipment selector 530 may select the first transport equipment 100 as the transport equipment to transport the cargo. For example, if the command is to transport a cargo from location A to location B in FIG. 2, since the optimal transport path includes only the first path 20, the transport equipment selector 530 may select the first transport equipment 100 as the transport equipment to transport the cargo.

In an embodiment, if the optimal transport path includes only the second path 30, the transport equipment selector 530 may select the second transport equipment 200 as the transport equipment to transport the cargo. For example, if the command is to transport a cargo from location C to location D in FIG. 2, since the optimal transport path includes only the second path 30, the transport equipment selector 530 may select the second transport equipment 200 as the transport equipment to transport the cargo.

In addition, in an embodiment, if the optimal transport path includes both the first path 20 and the second path 30, the transport equipment selector 530 may select both the first transport equipment 100 and the second transport equipment 200 as transport equipment to transport the cargo.

In an embodiment, the instructing the selected transport equipment to transport the cargo may include instructing, by the transport instructor 540, the selected transport equipment to transport the cargo along the optimal transport path.

In an embodiment, the checking the status of the selected transport equipment transporting the cargo may include checking, by a transport path checking unit 551, whether the transport equipment deviates from the optimal transport path, checking, by a transport equipment status checking unit 552, whether there is an abnormality in the transport equipment; determining, by a transport equipment restart determining unit 553, whether the transport equipment restarts, checking, by a cargo status checking unit 554, whether the cargo has deviated from the transport equipment and restarting, by a transport equipment restart executing unit 555, the transport equipment.

In an embodiment, the checking whether the transport equipment has deviated from the optimal transport path may include receiving the image of the transport equipment transporting the cargo captured in real time from the camera 300 to analyze the received captured image to check whether the transport equipment transporting the cargo deviates from the optimal transport path or not. If it is determined by the transport path checking unit 551 that the transport equipment is moving normally along the optimal transfer path, the process may proceed to checking whether there is an abnormality in the transport equipment. However, if it is determined by the transport path checking unit 551 that the transport equipment has deviated from the optimal transfer path, or is stopped or delayed, the process may be carried out again from the sorting the transport priority of the commands to transport.

In an embodiment, the checking whether there is an abnormality in the transport equipment may include checking, by the transport path checking unit 551, whether there is an abnormality in the transport equipment when the transport equipment is moving along the optimal transport path. The transport equipment status checking unit 552 may receive the captured image of the transport equipment transporting the cargo from the camera 300 in real time and receive the current status of the transport equipment from the status check sensor of the transport equipment, and analyzes the transmitted captured images and the current status of the transport equipment to check whether the transport equipment is normal or whether there is an abnormality such as the transport equipment being damaged or colliding with other transport equipment.

In an embodiment, if it is determined by the transport equipment status checking unit 552 that the transport equipment is normal, the transport equipment status checking unit 552 may continuously check the captured images transmitted from the camera 300 and monitor the transport equipment until it is moved to the destination location. In the process of monitoring the captured images of the camera 300, the position of the transport equipment may be adjusted if the cargo is moved between transport equipment. If the transport equipment temporarily deviates or collides with another one, the transport equipment may be sequentially moved and may be returned to the position before the collision. As described above, the transport equipment status checking unit 552 may continuously monitor the transport equipment transporting the cargo until the cargo is moved to the destination location.

In an embodiment, if it is determined by the transport equipment status checking unit 552 that the transport equipment is abnormal, the transport status may be analyzed. The analyzing the transport status of the transport equipment may include determining whether to restart the transport equipment or not.

In an embodiment, the determining whether to restart the transport equipment may include determining whether to restart the transport equipment if it is determined by the transport equipment status checker 552 that there is an abnormality in the transport equipment. The transport equipment restart determining unit 553 may determine whether to restart the transport equipment by comprehensively considering the degree of damage to the transport equipment, whether there is space to avoid other transport equipment that the transport equipment may collide with, etc.

In an embodiment, if it is determined by the transport equipment restart determining unit 553 that the transport equipment is not able to be restarted, an operator may be called to retrieve or repair the transport equipment.

On the contrary, in an embodiment, if it is determined by the transport equipment restart determining unit 553 that the transport equipment is able to be restarted, it is determined whether there is cargo on the transport equipment. If it is determined that there is no cargo on the transport equipment, the transport equipment may be restarted.

In addition, in an embodiment, if it is determined by the transport equipment restart determining unit 553 that the transport equipment is able to be restarted and there is cargo on the transport equipment, checking, by the cargo status checking unit 554, the status of the cargo may be carried out.

In an embodiment, the checking whether the cargo has deviated from the transport equipment may include checking whether the cargo has been properly seated on the transport equipment and whether the cargo has been damaged if it is determined, by the transport equipment restart determining unit 553 that the transport equipment is able to be restarted and there is cargo on the transport equipment. The cargo status checking unit 554 may receive the image of the transport equipment captured in real time from the camera 300 and analyze the received captured image to check whether the cargo is properly seated on the transport equipment and whether the cargo is damaged.

In an embodiment, if it is determined by the cargo status checking unit 554 that the cargo is not properly seated on the transport equipment or that the cargo is damaged, the operator may be called to retrieve the transport equipment.

On the other hand, in an embodiment, if it is determined by the cargo status checking unit 554 that the cargo is properly seated on the transport equipment, the transport equipment may be restarted.

In an embodiment, the restarting the transport equipment may include restarting, by the transport equipment restart executing unit 555, the transport equipment if it is determined by the transport equipment restart determining unit 553 that the transport equipment is able to be restarted and it is determined by the cargo status checking unit 554 that the cargo is properly seated on the transport equipment.

In an embodiment, when restarting the transport equipment, if the transport equipment collides with another transport equipment or a structure, the transport equipment restart executing unit 555 may analyze the images captured by the camera 300 and move the transport equipment so that it does not collide with another transport equipment or the structure. It may be determined that the restart has been completed when the transport equipment has been moved to a position where it does not collide with other transport equipment or a structure, and the process may be carried out again from the sorting the transport priority of the commands.

In an embodiment, if the transport equipment is restarted due to a simple error, it may be determined that the restart of the transport equipment has been completed, and the process may be carried out again from the sorting the transport priority of the commands.

On the other hand, in an embodiment, if the transport equipment is not restarted even after being restarted multiple times, the transport equipment may be moved to a standby location and the operator may be called to retrieve the transport equipment.

It should be understood, however, that the aspects and features of the invention are not restricted to those set forth herein. The above and other aspects of the invention will become more apparent to one of ordinary skill in the art to which the invention pertains.

What is claimed is:

1. An automatic transport system comprising:
first transport equipment transporting a cargo along a first path;
second transport equipment transporting the cargo along a second path, the second transport equipment being of a different type from the first transport equipment;
one or more cameras disposed on the first path and on the second path to capture images of the first path and the second path;
a host controller configured to issue a command to transport the cargo; and
an integrated controller configured to control the first transport equipment and the second transport equipment pursuant to the command to transport.

2. The system of claim 1, wherein the integrated controller comprises:
a transport path generator that generates an optimal transport path of the cargo based on the command to transport;
a transport equipment selector that selects transport equipment based on the optimal transport path, wherein the transport equipment includes one or more of the first transport equipment and the second transport equipment;
a transport instructor that instructs the transport equipment selected by the transport equipment selector to transport the cargo; and
a transport status checker that checks a status of the selected transport equipment transporting the cargo pursuant to the instruction of the transport instructor.

3. The system of claim 2, wherein the host controller issues the command to transport the cargo from an initial location to a destination location, and
wherein the transport path generator analyzes the images to generate an optimal transport path for transporting the cargo from the initial location to the destination location.

4. The system of claim 2, wherein the transport equipment selector
selects the first transport equipment if the optimal transport path generated by the transport path generator comprises the first path,
selects the second transport equipment if the optimal transport path generated by the transport path generator comprises the second path, and
selects the first transport equipment and the second transport equipment if the optimal transport path generated by the transport path generator comprises the first path as well as the second path.

5. The system of claim 4, wherein if both the first transport equipment and the second transport equipment are selected by the transport equipment selector, the cargo is moved from the first transport equipment to the second transport equipment, or from the second transport equipment to the first transport equipment.

6. The system of claim 2, wherein the integrated controller further comprises: a transport priority sorter that sorts transport priorities of commands to transport,
wherein the transport priority sorter sorts multiple commands in issued order if the multiple commands are issued from the host controller, and the transport path generator generates optimal transport paths for the commands in the issued order.

7. The system of claim 6, wherein the transfer priority sorter sorts an urgent command as a highest priority if the urgent command is issued from the host controller.

8. The system of claim 2, wherein the transport status checker comprises:
a transport path checking unit that checks whether the transport equipment deviates from the optimal transport path;
a transport equipment status checking unit that checks whether there is an abnormality in the transport equipment; and
a transport equipment restart determining unit that determines whether to restart the transport equipment if it is determined by the transport equipment status checking unit that there is the abnormality in the transport equipment.

9. The system of claim 8, wherein the transport status checker further comprises:
a cargo status checking unit that checks whether the cargo has deviated from the transport equipment if it is determined by the transport equipment restart determining unit that the transport equipment is able to be restarted.

10. The system of claim 9, wherein the transport status checker further comprises:
a transport equipment restart executing unit that restarts the transport equipment if it is determined by the transport equipment restart determining unit that the transport equipment is able to be restarted and it is determined by the cargo status checking unit that the cargo has not deviated from the transport equipment.

11. The system of claim 1, wherein the first transport equipment comprises a first status check sensor that checks a current status of the first transport equipment, and the second transport equipment comprises a second status check sensor that checks a current status of the second transport equipment.

12. The system of claim 1, wherein the first transport equipment is one selected from among an over head shuttle (OHS), a tray over head shuttle (TOHS), an automatic guided vehicle (AGV), a laser guided vehicle (LGV), a rail guided vehicle (RGV), and an autonomous mobile robot (AMR), and
wherein the second transport equipment is one selected from among an over head shuttle (OHS), a tray over head shuttle (TOHS), an automatic guided vehicle (AGV), a laser guided vehicle (LGV), a rail guided vehicle (RGV), and an autonomous mobile robot (AMR).

13. A method for automatic transport, the method comprising:
issuing, by a host controller, a command to transport cargo;
capturing, by a camera, images of a first path and a second path;
generating, by a transport path generator, an optimal transport path for the cargo based on the command to transport;
selecting, by a transport equipment selector, at least one of the first transport equipment and the second transport equipment based on the optimal transport path;
instructing, by a transport instructor, the selected transport equipment to transport the cargo; and
checking, by a transport status checker, a status of the selected transport equipment transporting the cargo.

14. The method of claim 13, wherein the command to transport is a command to transport the cargo from an initial location to a destination location, and
wherein the generating the optimal transport path for the cargo comprises: analyzing, by the transport path generator, the images captured by the camera to generate the optimal transport path for transporting the cargo from the initial location to the destination location.

15. The method of claim 13, wherein the selecting the transport equipment comprises:
selecting, by the transport equipment selector, the first transport equipment if the optimal transport path comprises the first path,
selecting, by the transport equipment selector, the second transport equipment if the optimal transport path comprises the second path, and
selecting, by the transport equipment selector, the first transport equipment and the second transport equipment if the optimal transport path comprises the first path as well as the second path.

16. The method of claim 13, further comprising:
sorting, by the transfer priority sorter, transport priorities of multiple commands if the host controller issues the multiple commands.

17. The method of claim 16, wherein the sorting the transport priorities of the multiple commands comprises:
sorting, by the transport priority sorter, the multiple commands in the issued order, and
sorting an urgent command as a highest priority if the urgent command is among the multiple commands.

18. The method of claim 13, wherein the transport status checker comprises: a transport path checking unit, a transport equipment status checking unit, and a transport equipment restart determining unit,
wherein the checking the status of the selected transport equipment transporting the cargo comprises:
checking, by transport path checking unit, whether the transport equipment deviates from the optimal transport path;
checking, by the transport equipment status checking unit, whether there is an abnormality in the transport equipment; and
determining, by the transport equipment restart determining unit, whether to restart the transport equipment if it is determined by the transport equipment status checking unit that there is an abnormality in the transport equipment.

19. The method of claim 18, wherein the transport status checker further comprises: a cargo status checking unit, and
wherein the checking the status of the selected transport equipment transporting the cargo further comprises: checking, by the cargo status checking unit, whether the cargo has deviated from the transport equipment if it is determined by the transport equipment restart determining unit that the transport equipment is able to be restarted.

20. The method of claim 19, wherein the transport status checker further comprises: a transport equipment restart executing unit, and
wherein the checking the status of the selected transport equipment transporting the cargo further comprises: restarting, by the transport equipment restart executing unit, the transport equipment if it is determined by the transport equipment restart determining unit that the transport equipment is able to be restarted and is determined by the cargo status checking unit that the cargo has not deviated from the transport equipment.
